(19) United States
(12) Patent Application Publication
(10) Pub. No.: US 2023/0252390 A1
(43) Pub. Date: Aug. 10, 2023

(54) SYSTEM AND METHOD FOR PROVIDING SITE RELIABILITY ENGINEERING LEADERBOARD

(71) Applicant: JPMorgan Chase Bank, N.A., New York, NY (US)

(72) Inventors: Damien DENNIS, Springfield, OH (US); Tony PRINCIPATO, Katy, TX (US); Parankush CHUNCHU, (US); Brett BENES, Houston, TX (US); Julie SCHLABACH, Willis, TX (US); James REID, Cumming, GA (US)

(73) Assignee: JPMorgan Chase Bank, N.A., New York, NY (US)

(21) Appl. No.: 17/655,616

(22) Filed: Mar. 21, 2022

(30) Foreign Application Priority Data
Feb. 4, 2022 (IN) 202211006024

(51) Int. Cl. G06Q 10/06

(52) U.S. Cl. CPC G06Q 10/06393

(57) ABSTRACT

A method for providing common objective performance metrics across various teams, and guiding performance of targeted behaviors based on site reliability engineering principles for improved system reliability and performance is disclosed. The method includes obtaining performance metrics of an application; capturing target performance metrics of the application via an ingestion service; performing one or more calculations for determining a set of scores, one for each of a plurality of performance categories; generating a rank based on the set of scores; generating at least one action item for each of the set of scores, along with corresponding score improvement to be awarded upon completion; and displaying, on a user interface, at least one of the set of scores for each of the plurality of performance categories.

### CROSS-REFERENCE TO RELATED APPLICATION(S)

This application claims priority benefit from Indian Application No. 202211006024, filed Feb. 4, 2022, which is hereby incorporated by reference in its entirety.

### TECHNICAL FIELD

This disclosure generally relates to a system and method for providing common objective performance metrics across various teams, and guiding performance of targeted behaviors based on site reliability engineering principles for improved system reliability and performance.

### BACKGROUND

The developments described in this section are known to the inventors. However, unless otherwise indicated, it should not be assumed that any of the developments described in this section qualify as prior art merely by virtue of their inclusion in this section, or that those developments are known to a person of ordinary skill in the art.

Presently, various teams or groups within an organization have no way to quantitatively or objectively measure their maturity metrics with respect to Site Reliability Engineering (SRE) principles. For example, no quantitative measurements indicating in effectiveness in reducing technical resource utilization, amount of coverage in monitoring, and/or stability of application are provided. Accordingly, SRE principles are determined subjectively, and thereby providing uncertainty of effectiveness or maturity level of a team or a group, which may lead to various inefficiencies of technical services and resources.

### SUMMARY

According to an aspect of the present disclosure, a method for providing objective performance evaluations across site reliability engineering teams responsible for different applications is provided. The method includes performing, using a processor and a memory: obtaining performance metrics of an application; capturing target performance metrics of the application via an ingestion service; performing one or more calculations for determining a set of scores, one for each of a plurality of performance categories; generating a rank based on the set of scores; generating at least one action item for each of the set of scores, along with corresponding score improvement to be awarded upon completion, wherein the score improvement is different for different performance categories; and displaying, on a user interface, at least one of the set of scores for each of the plurality of performance categories, the performance metrics corresponding to the set of scores, the rank, the at least one action item along with corresponding score improvement to be awarded upon completion.

According to another aspect of the present disclosure, the application includes a monitoring system for tracking of system metrics impacted by operation of the application.

According to another aspect of the present disclosure, the method further includes the system metrics include utilization of a technical resource.

According to yet another aspect of the present disclosure, the set of scores is calculated in view of baseline metrics, the baseline metrics being based on previous performance metrics of the application.

According to another aspect of the present disclosure, the set of scores is determined using at least one mathematical model.

According to a further aspect of the present disclosure, the at least one mathematical model includes a pairwise comparison model or an analytic hierarchy process (AHP) model.

According to yet another aspect of the present disclosure, the set of scores is further determined in view of at least one of a service level agreement (SLA) and service level objective (SLO).

According to a further aspect of the present disclosure, the method further includes aggregating the set of scores with scores of one or more applications based on a relationship between the application and the one or more applications; and displaying, on the user interface, the aggregated scores.

According to another aspect of the present disclosure, the method further includes determining a maturity level of a site reliability engineering team responsible for the application based on the set of scores.

According to a further aspect of the present disclosure, the set of scores are updated at predetermined intervals.

According to a further aspect of the present disclosure, the rank is generated for a site reliability engineering team responsible for the application, and with respect to other SRE teams.

According to a further aspect of the present disclosure, the plurality of performance categories includes a response, react and reflect, the response referring to responsiveness of a site reliability engineering team responsible for the application in preventing or minimizing an outage or failure of the application, the react referring to the SRE team's ability to resolve the outage or failure of the application upon occurrence, and the reflect referring to future actions or guidance for preventing repeat occurrence of the outage of failure and/or minimizing impact to downstream applications upon occurrence of the outage or failure.

According to a further aspect of the present disclosure, weighting of a score for the response is higher than weighting of the react performance category or the reflect performance category.

According to a further aspect of the present disclosure, performing an action item for the response performance category will raise a score amount higher than performing an action item for the react performance category or the reflect performance category.

According to another aspect of the present disclosure, the method further includes determining an impact of upstream applications or services to the performance metrics of the application, in which the set of scores is determined based on the impact of the upstream applications or services.

According to another aspect of the present disclosure, the set of scores is normalized in view of a number of golden signals in view of data volume processed.

According to another aspect of the present disclosure, the set of scores is determined using one or more machine learning or artificial intelligence algorithms.

According to another aspect of the present disclosure, the at least one action item and the corresponding score to be awarded are determined using one or more machine learning or artificial intelligence algorithms.

According to another aspect of the present disclosure, a system for providing objective performance evaluations across site reliability engineering teams responsible for different applications is disclosed. The system includes at least one processor; at least one memory; and at least one communication circuit. The at least one processor is configured to perform: obtaining performance metrics of an application; capturing target performance metrics of the application via an ingestion service; performing one or more calculations for determining a set of scores, one for each of a plurality of performance categories; generating a rank based on the set of scores; generating at least one action item for each of the set of scores, along with corresponding score improvement to be awarded upon completion, wherein the score improvement is different for different performance categories; and displaying, on a user interface, at least one of the set of scores for each of the plurality of performance categories, the performance metrics corresponding to the set of scores, the rank, the at least one action item along with corresponding score improvement to be awarded upon completion.

According to another aspect of the present disclosure, a non-transitory computer readable storage medium that stores a computer program for providing objective performance evaluations across site reliability engineering teams responsible for different applications is disclosed. The computer program, when executed by a processor, causing a system to perform a process including obtaining performance metrics of an application; capturing target performance metrics of the application via an ingestion service; performing one or more calculations for determining a set of scores, one for each of a plurality of performance categories; generating a rank based on the set of scores; generating at least one action item for each of the set of scores, along with corresponding score improvement to be awarded upon completion, wherein the score improvement is different for different performance categories; and displaying, on a user interface, at least one of the set of scores for each of the plurality of performance categories, the performance metrics corresponding to the set of scores, the rank, the at least one action item along with corresponding score improvement to be awarded upon completion.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a site reliability engineering leaderboard system in accordance with an exemplary embodiment.

FIG. 2 illustrates an exemplary diagram of a network environment with a site reliability engineering leaderboard system in accordance with an exemplary embodiment.

FIG. 3 illustrates a system diagram for implementing a site reliability engineering leaderboard system in accordance with an exemplary embodiment.

FIG. 4 illustrates a method for providing site reliability engineering leaderboard metrics in accordance with an exemplary embodiment.

FIG. 5 illustrates a system for providing a site reliability engineering leader board in accordance with an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

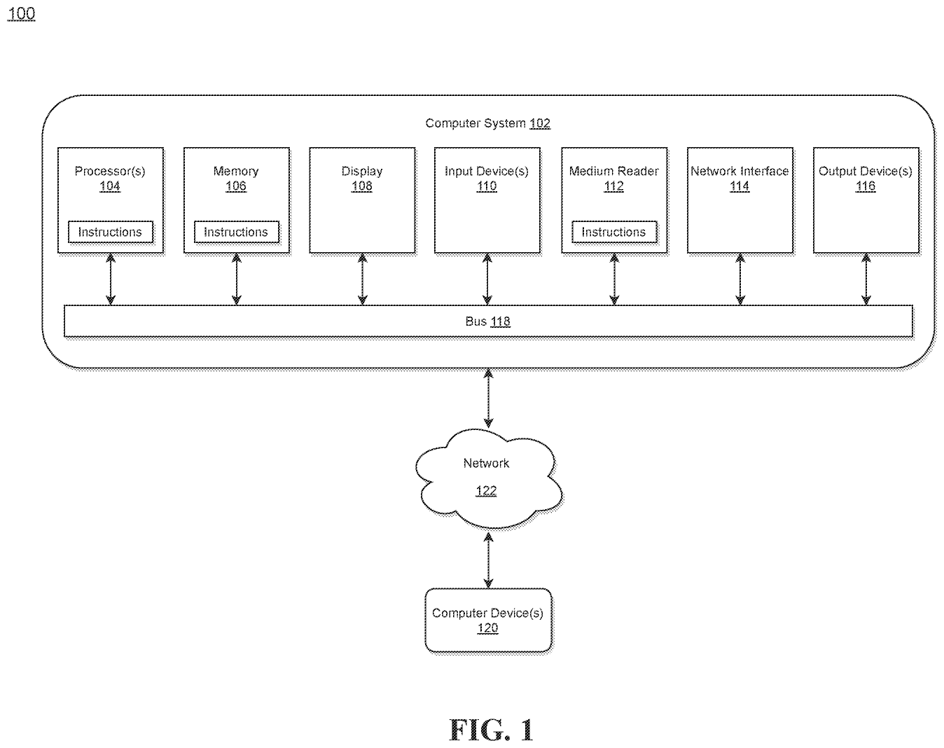

FIG. 1 illustrates a computer system for implementing a site reliability engineering leaderboard system in accordance with an exemplary embodiment.

The system 100 is generally shown and may include a computer system 102, which is generally indicated. The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The network interface 114 may include, without limitation, a communication circuit, a transmitter or a receiver. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive.

Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and an operation mode having parallel processing capabilities. Virtual computer system processing can be constructed to implement one or more of the methods or functionality as described herein, and a processor described herein may be used to support a virtual processing environment.

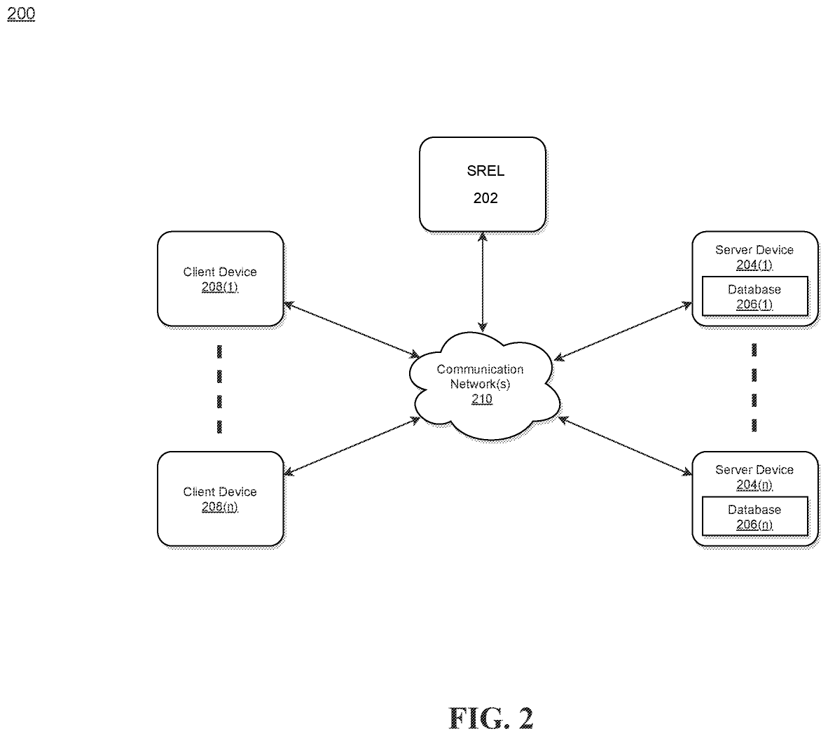

FIG. 2 illustrates an exemplary diagram of a site reliability engineering leaderboard system in accordance with an exemplary embodiment.

A site reliability engineering leaderboard (SREL) system 202 may be the same or similar to the computer system 102 as described with respect to FIG. 1.

The SREL system 202 may store one or more applications that can include executable instructions that, when executed by the SREL system 202, cause the SREL system 202 to perform actions, such as to execute, transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment or other networking environments. The application(s) may be executed within or as virtual machine(s) or virtual server(s) that may be managed in a cloud-based computing environment. Also, the application(s), and even the SREL system 202 itself, may be located in virtual server(s) running in a cloud-based computing environment rather than being tied to one or more specific physical network computing devices. Also, the application(s) may be running in one or more virtual machines (VMs) executing on the SREL system 202. Additionally, in one or more embodiments of this technology, virtual machine(s) running on the SREL system 202 may be managed or supervised by a hypervisor.

In the network environment 200 of FIG. 2, the SREL system 202 is coupled to a plurality of server devices 204(1)-204(n) that hosts a plurality of databases 206(1)-206(n), and also to a plurality of client devices 208(1)-208(n) via communication network(s) 210. A communication interface of the SREL system 202, such as the network interface 114 of the computer system 102 of FIG. 1, operatively couples and communicates between the SREL system 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the SREL system 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The SREL system 202 may be a standalone device or integrated with one or more other devices or apparatuses, such as one or more of the server devices 204(1)-204(n), for example. In one particular example, the SREL system 202 may be hosted by one of the server devices 204(1)-204(n), and other arrangements are also possible. Moreover, one or more of the devices of the SREL system 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the SREL system 202 via the communication network(s) 210 according to the HTTP-based protocol, for example, although other protocols may also be used. According to a further aspect of the present disclosure, in which the user interface may be a Hypertext Transfer Protocol (HTTP) web interface, but the disclosure is not limited thereto.

The server devices 204(1)-204(n) may be hardware or software or may represent a system with multiple servers in a pool, which may include internal or external networks. The server devices 204(1)-204(n) hosts the databases 206(1)-206(n) that are configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

According to exemplary embodiments, the client devices 208(1)-208(n) in this example may include any type of computing device that can facilitate the implementation of the SREL system 202 that may efficiently provide a platform for implementing a cloud native SREL module, but the disclosure is not limited thereto.

The client devices 208(1)-208(n) may run interface applications, such as standard web browsers or standalone client applications, which may provide an interface to communicate with the SREL system 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the SREL system 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the SREL system 202, the server devices 204(1)-204(n), or the client devices 208(1)-208(n), for example, may be configured to operate as virtual instances on the same physical machine. For example, one or more of the SREL system 202, the server devices 204(1)-204(n), or the client devices 208(1)-208(n) may operate on the same physical device rather than as separate devices communicating through communication network(s) 210. Additionally, there may be more or fewer SREL systems 202, server devices 204(1)-204(n), or client devices 208(1)-208(n) than illustrated in FIG. 2. According to exemplary embodiments, the SREL system 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

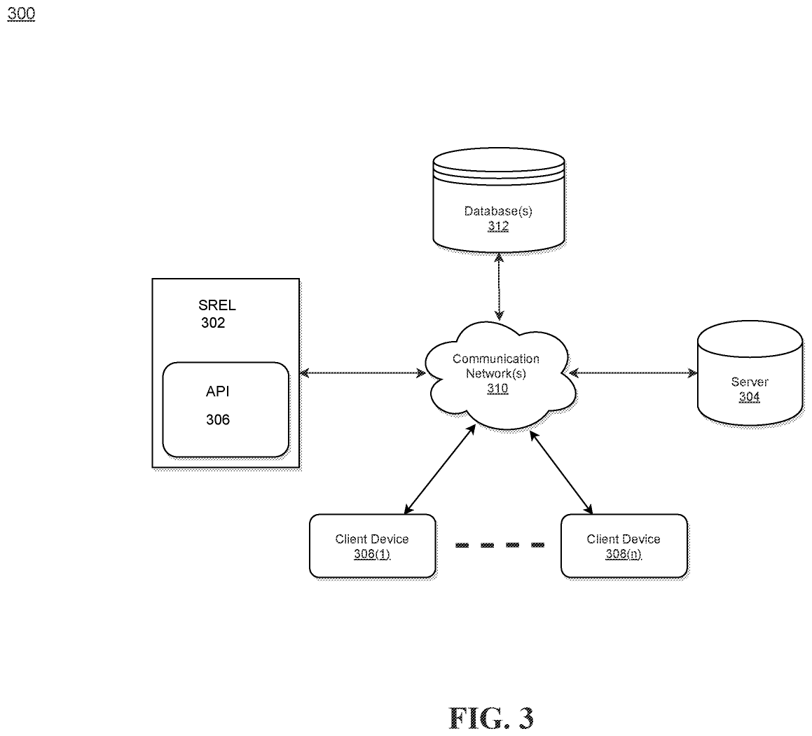

FIG. 3 illustrates a system diagram for implementing a site reliability engineering leaderboard system in accordance with an exemplary embodiment.

As illustrated in FIG. 3, the system 300 may include a site reliability engineering leaderboard system 302 within which a group of API modules 306 is embedded, a server 304, a database(s) 312, a plurality of client devices 308(1) . . . 308(n), and a communication network 310.

According to exemplary embodiments, the SREL system 302 including the API modules 306 may be connected to the server 304, and the database(s) 312 via the communication network 310. Although there is only one database has been illustrated, the disclosure is not limited thereto. Any number of databases may be utilized. The SREL System 302 may also be connected to the plurality of client devices 308(1) . . . 308(n) via the communication network 310, but the disclosure is not limited thereto.

According to exemplary embodiment, the SREL system 302 is described and shown in FIG. 3 as including the API modules 306, although it may include other rules, policies, modules, databases, or applications, for example. According to exemplary embodiments, the database(s) 312 may be embedded within the SREL system 302. According to exemplary embodiments, the database(s) 312 may be configured to store configuration details data corresponding to a desired data to be fetched from one or more data sources, user information data etc., but the disclosure is not limited thereto.

According to exemplary embodiments, the API modules 306 may be configured to receive real-time feed of data or data at predetermined intervals from the plurality of client devices 308(1) . . . 308(n) via the communication network 310.

The API modules 306 may be configured to implement a user interface (UI) platform that is configured to enable SREL as a service for a desired data processing scheme. The UI platform may include an input interface layer and an output interface layer. The input interface layer may request preset input fields to be provided by a user in accordance with a selection of an automation template. The UI platform may receive user input, via the input interface layer, of configuration details data corresponding to a desired data to be fetched from one or more data sources. The user may specify, for example, data sources, parameters, destinations, rules, and the like. The UI platform may further fetch the desired data from said one or more data sources based on the configuration details data to be utilized for the desired data processing scheme, automatically implement a transformation algorithm on the desired data corresponding to the configuration details data and the desired data processing scheme to output a transformed data in a predefined format, and transmit, via the output interface layer, the transformed data to downstream applications or systems.

The plurality of client devices 308(1) . . . 308(n) are illustrated as being in communication with the SREL system 302. In this regard, the plurality of client devices 308(1) . . . 308(n) may be “clients” of the SREL system 302 and are described herein as such. Nevertheless, it is to be known and understood that the plurality of client devices 308(1) . . . 308(n) need not necessarily be “clients” of the SREL system 302, or any entity described in association therewith herein. Any additional or alternative relationship may exist between either or both of the plurality of client devices 308(1) . . . 308(n) and the SREL system 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. According to exemplary embodiments, the server 304 may be the same or equivalent to the server device 204 as illustrated in FIG. 2.

The process may be executed via the communication network 310, which may comprise plural networks as described above. For example, in an exemplary embodiment, one or more of the plurality of client devices 308(1) . . . 308(n) may communicate with the

SREL system 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The SREL system 302 may be the same or similar to the SREL system 202 as described with respect to FIG. 2, including any features or combination of features described with respect thereto.

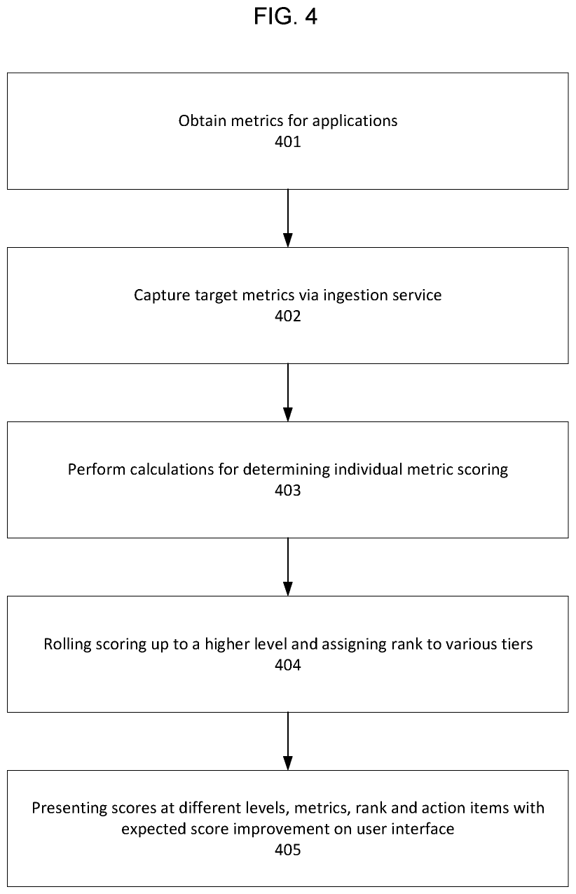

FIG. 4 illustrates a method for providing site reliability engineering leaderboard metrics in accordance with an exemplary embodiment.

Site reliability engineering (SRE) may refer to a set of principles and practices that incorporate aspects of software engineering, which is applied to resolve infrastructure and/or operation problems. For example, SRE principles may be applied to create scalable and highly reliable software products or services. An SRE team may be responsible for availability, latency, performance, efficiency, change management, monitoring, emergency response, capacity planning and the like of a particular service or application. In other words, performance of an SRE team may directly impact performance or operational effectiveness or efficiency of a service or application the SRE team is responsible for. In an example, such operational effectiveness or efficiency may have a bearing on efficiencies of technical resources (e.g., CPU, memory, bandwidth and etc.) utilized by an organization. Accordingly, a performance of an SRE team may be reflected in performance or reliability of a service or application.

Further, an SRE team may strive to meet a service-level agreement (SLA), which may specify one or more service-level objectives (SLOs) to be met according to its maturity level. For example, one SLA may be suitable for less mature SRE teams, and another SLA may be suitable for more mature SRE teams. Further, for system stability and reliability, it may be desired to have SRE teams mature quickly and reliably.

However, SRE principles may be difficult to apply to where data, such as those indicating a maturity level of a team, are unavailable. In this aspect, site reliability engineering leaderboard (SREL) system may be implemented to provide visibility of objective performance and/or the maturity level to a respective SRE team, and automatically indicate one or more ways for improving its performance and/or maturity level for improvement of a corresponding service, application, and/or system. Such performance improvements by the SRE team may lead to improved system operations, which includes, without limitation, improved CPU utilization, memory utilization, latency, and the like.

According to exemplary aspects, the site reliability engineering leaderboard system may utilize metrics from various data sources to drive implementation of SRE principles and behaviors using a data driven approach. For example, the SREL system may pull hard numbers, such as volume of alerting (e.g., failures, outages, high CPU/memory utilization, latency in responsiveness and the like), service level objective (SLO) metrics, and/or number of failed changes, and the like. SLO metrics may include, without limitation, CPU utilization, memory utilization, percentage of availability (i.e., uptime), number of failures/outages, and the like. In an example, the number of failures/outages may be distinguished between preventable failures/outages for situations a respective SRE team may have control, and unpreventable failures/outages for situation where the respective SRE team may not have control (e.g., upstream disruptions). Based on such numbers, the SREL system may be able to objectively determine how well a team or an application is performing with respect to the SRE principles. Further, based on such numbers, SREL system may be able to determine the respective team/application's performance with respect to its baseline, peers (e.g., other SRE teams), SLA/SLO agreements and the like.

In operation 401, metrics are acquired or received from one or more applications. For example, applications utilized in an organization may include a monitoring system or mechanism, which may track technical resource utilization/performance levels. According to exemplary aspects, such metrics may be acquired or transmitted at predetermined intervals, at occurrence of certain events (e.g., CPU utilization reaching above a predefined threshold), or continuously. However, aspects of the present disclosure are not limited thereto, such that amount of metrics acquired may be modified in accordance with a maturity level a SRE team, which may be responsible for reliability of a particular service or application. In an example, a higher performing or more mature SRE team or corresponding service or application may require less metrics to be required than lower performing or younger applications. Such distinctions in acquired data metrics may assist in reducing technical resources for redeployment to other services.

In operation 402, metrics are captured via an ingestion service. According to exemplary aspects, an ingestion service may convert raw data from applications or services into normalized, query-ready schemas. In an example, the acquired or received metrics may be processed and/or may be categorized based on one or more attributes. For example, CPU metrics, memory metrics, latency metrics, failures, uptime/downtime and the like may be categorized. Further, the ingestion service may distinguish between target data that may be utilized in performing scoring calculations, and other extraneous data that may or may not be utilized in the measuring of a team's performance.

In operation 403, one or more calculations are performed for determining individual metric scoring. In an example, metric scoring may be determined for one or more SRE teams or applications. According to exemplary aspects, an overall score may be provided to respective SRE teams and/or corresponding applications. Further, according to exemplary aspects, one or more scores may be calculated using mathematical models or formulations. For example, mathematical models or formulations may include, without limitation, a pairwise comparison model, analytic hierarchy process (AHP) model and the like. Further, the scores may be calculated by normalizing attributes of a team. For example, a score of an SRE team with 100 golden signals (e.g., latency, traffic, errors, and saturation) may be compared with a score of another SRE team with 3000 golden signals by normalizing its data volume, for performing objective comparisons.

Moreover, along with the overall score, scores may be individually attributed to predefined categories, which may measure different aspects of SRE principles. For example, scores may be individually assigned to three categories, such as response, react, and reflect. However, aspects of the present disclosure are not limited thereto, such that more or less categories may be separately scored. According to exemplary aspects, impact or weighting of scores in the separately categories may be higher than another. For example, a score in a first predefined category may have a higher impact or weight on the overall score of the SRE team than a score in a second predefined category.

According to exemplary aspects, a response category may refer to an SRE team's proactivity in preventing or minimizing an outage or other failures (e.g., analyzing system readiness ahead of data migration). A react category may refer to the SRE's team's ability to resolve the detected outage or failure, and/or the team's ability to minimize impact to customers or dependents during the detected outage or failure (e.g., how quickly was an outage/failure resolved and how many downstream applications/services were impacted). A reflect category may refer to action items or future guidance for better preventing such outages/failures, and/or minimizing impact to other parties or nodes upon such outages/failures (e.g., analysis of root cause and actions/plans established or taken for reducing likelihood of seeing same type of outages or failures).

Further, the above noted scores may be provided with respect to its baseline metrics or scores. According to exemplary aspects, an improving score trend is expected or desired as a team matures. Based on the comparison with the baseline metrics or scores, a team may be tracked for its rate of improvement and/or any downtrend in performance. Moreover, one or more scores of an SRE team may be displayed along with one or more scores of other SRE team, a larger group of SRE teams belonging to a specific business unit, organization as a whole, and the like for providing of comparative performance measures.

In addition to the one or more scores calculated, various action items for improving the scores may be provided. In an example, the action items may be provided according to its scoring category (e.g., response, react, or reflect). According to exemplary aspects, each action item may provide a certain improvement that is expected in scoring, in categorical scoring and/or overall scoring. In an example, scoring for categories may be weighed differently from one another, such that an action directed to improving reactiveness may increase score a larger amount that an action directed to improving a reflect or a react category. Accordingly, based on score improvement provided for each action item, the SREL system may be able to direct a desired SRE behavior or practices to be taken up by a respective team.

In an example, a list of action items and/or corresponding expected or simulated score improvements may be provided using or in view of one or more mathematical models or formulations. However, aspects of the present disclosure are not limited thereto, such that a list of action items and corresponding improvements to score may be provided using one or more machine learning (ML) or artificial intelligence (AI) algorithms. Moreover, in some cases, the one or more ML or AI algorithms may also implement certain action items for improving a score.

In an example, AI or ML algorithms may be executed to perform data pattern detection, and to provide an output or render a decision based on the data pattern detection. More specifically, an output may be provided based on a historical pattern of data, such that with more data or more recent data, more accurate outputs and/or decisions may be provided or rendered. Accordingly, the ML or AI models may be constantly updated after a predetermined number of runs or iterations. According to exemplary aspects, machine learning may refer to computer algorithms that may improve automatically through use of data. Machine learning algorithm may build an initial model based on sample or training data, which may be iteratively improved upon as additional data are acquired.

More specifically, machine learning/artificial intelligence and pattern recognition may include supervised learning algorithms such as, for example, k-medoids analysis, regression analysis, decision tree analysis, random forest analysis, k-nearest neighbors analysis, logistic regression analysis, 5-fold cross-validation analysis, balanced class weight analysis, and the like. In another exemplary embodiment, machine learning analytical techniques may include unsupervised learning algorithms such as, for example, Apriori analysis, K-means clustering analysis, etc. In another exemplary embodiment, machine learning analytical techniques may include reinforcement learning algorithms such as, for example, Markov Decision Process analysis, and the like.

In another exemplary embodiment, the ML or AI model may be based on a machine learning algorithm. The machine learning algorithm may include at least one from among a process and a set of rules to be followed by a computer in calculations and other problem-solving operations such as, for example, a linear regression algorithm, a logistic regression algorithm, a decision tree algorithm, and/or a Naive Bayes algorithm.

In another exemplary embodiment, the ML or AI model may include training models such as, for example, a machine learning model which is generated to be further trained on additional data. Once the training model has been sufficiently trained, the training model may be deployed onto various connected systems to be utilized. In another exemplary embodiment, the training model may be sufficiently trained when model assessment methods such as, for example, a holdout method, a K-fold-cross-validation method, and a bootstrap method determine that at least one of the training model's least squares error rate, true positive rate, true negative rate, false positive rate, and false negative rates are within predetermined ranges.

In another exemplary embodiment, the training model may be operable, i.e., actively utilized by an organization, while continuing to be trained using new data. In another exemplary embodiment, the ML or AI models may be generated using at least one from among an artificial neural network technique, a decision tree technique, a support vector machines technique, a Bayesian network technique, and a genetic algorithms technique.

In operation 404, the calculated scores are then rolled up to a higher level (e.g., business unit or organization), and based on the rolled up scores, a rank is assigned to various tiers. In an example, the calculated scores may be rolled up in accordance to an organization chart. Accordingly, SRE performance may be viewed for the entire organization, smaller groups, or individual teams.

For example, a score of an SRE team belonging to a particular group or organization may be rolled up with scores of other SRE teams belonging to the same group or organization unit. Further, a score of an SRE team responsible for an application may be rolled up together with scores of other SRE teams based on the application's relationship with other applications, eco-system, network, organization or the like. Also, the scores may be rolled up at different levels (e.g., application level, team level, organization level and the like). Based on the scores, a rank may be assigned to the team, group, application, organization or the like.

In operation 405, scores and underlying metrics are presented on a user interface, such as an SRE leaderboard dashboard. More specifically, an overall score, and individual categorical scores (e.g., scores for response, react and reflect categories) making up the overall score may be presented on the user interface. Further, weighting of the categorical scores on the overall score may be presented or available for view. In addition, underlying or supporting metrics for the scores may be provided for justification. In an example, supporting or underlying metrics may indicate availability rate, number of incidents/failures/outages, and other SLOs. The supporting or underlying metrics may omit failures or outages caused by upstream services or applications, but may include incidents of such occurrences for review.

Based on the provided scores, one or more corresponding ranks may be provided. For example, a rank may be applied to the overall score of an SRE team to indicate where the SRE team falls with respect to other SRE teams. In an example, an applied rank may be a numerical rank (e.g., 1, 2, 3, 4 and etc.) or a categorical rank (e.g., gold, silver, bronze and etc.) Further, separate rank may be applied to individual categorical scores, such that strengths and weaknesses of an SRE team are apparent to a user.

Further to the above, the calculated score may be presented along with respective baselines to show performance trend, as well as target score and/or peer scores. In an example, the baseline may be provided based on prior data. Further, the baseline may be established based on a range of time or based on an entire data set. Also, a trend of scores over a period of time may be utilized to indicate a maturity level of an SRE team.

According to exemplary aspects, various scores or metrics may be provided for differing organizational groupings on the user interface. For example, scores (e.g., overall and categorical) for various organization groupings may be provided (e.g., organization as a whole, by organization groupings/divisions, by application organization and the like). Further, an application or service specific score may be provided to indicate a reliability or maturity level of the respective application. In an example, the application or service specific score may be derived from one or more scores from a corresponding SRE team.

Also, one or more action items or behaviors for improving corresponding scores may be provided. In an example, each of the action items or behaviors having potential for improving score, may increase score in differing amounts based on category. For example, an action item for improving a response category may increase a score by a higher amount than an action item for improving a reflect category. The differing score increase may be based on differing weighting provided to each of the categories. The weighting applied may be predetermined based on a mathematical model or may be a variable value that may be adjusted in real time or in predetermined intervals by one or more ML or AI algorithms.

By providing present scores, rank, metrics in view of a baseline, a respective SRE team may be provided with an objective view of its performance with respect to its target and according to its performance categories. Further, by providing action items or behaviors along with corresponding score improvement potential, the respective SRE team is provided with a roadmap for increasing technical performance (e.g., reliability, CPU utilization, memory utilization, latency, and the like) of a corresponding service or application. Accordingly, specific actions or behaviors by the SRE team may be directed or encouraged to be adopted according to underlying SRE principles for increased performance or reliability of the corresponding service or application.

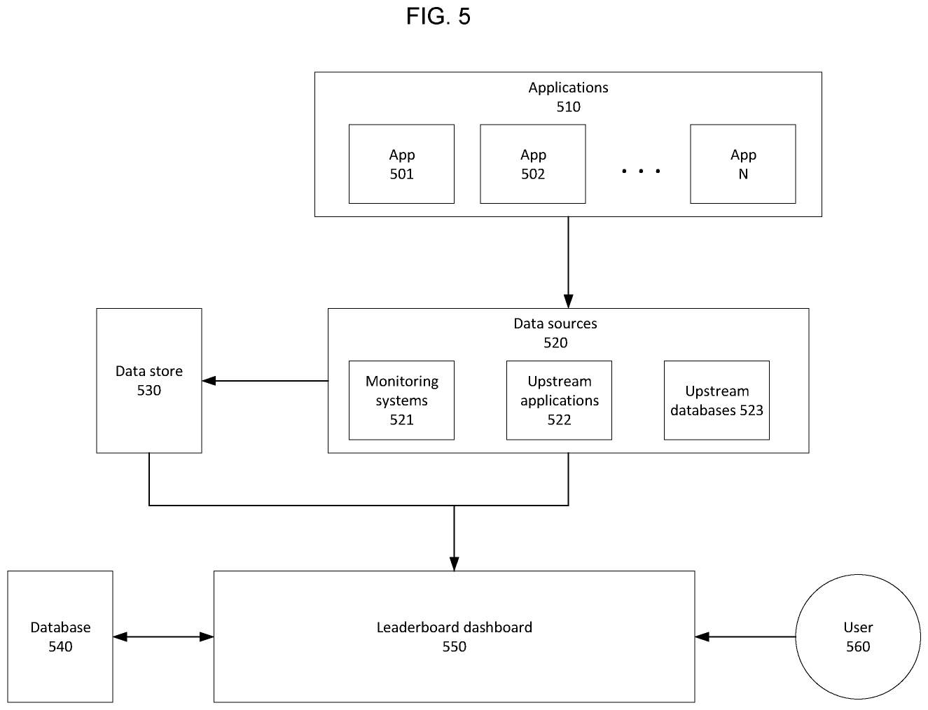

FIG. 5 illustrates a health check system process flow in accordance with an exemplary embodiment.

Application 510 includes application 501, application 502, and up to application N, where N is an integer. However, aspects of the disclosure are not limited thereto, such that less number of applications may be included. Further, Application 510 may not be limited to an application, but may include a system, a network, a service or the like. According to exemplary aspects, one or more of the applications/system/service may have a monitoring system that tracks various technical performance metrics. Performance metrics may include, without limitation, CPU utilization, memory utilization, uptime, latency, detection of anomalies or the like. The performance metrics may be pushed or pulled to the data sources 520. According to exemplary aspects, the performance metrics may be pushed or pulled at predetermined intervals, or in response to occurrence of a predetermined event. For example, the predetermined event may include, without limitation, CPU utilization above a certain threshold, latency above a certain threshold, memory utilization above a certain threshold, application outage/failure, detection of an anomaly or the like. However, aspects of the present disclosure are not limited thereto, such that data sources 520 may pull performance metrics from the application 510 based on its configurations.

Data sources 520 includes monitoring systems 521, upstream applications 522, and upstream databases 523. According to exemplary aspects, the monitoring systems 521 track events or incidents of one or more applications 510. For example, the monitoring systems 521 may perform monitoring of applications to detect an event (e.g., outage, failure, unresponsiveness, latency or the like) in one or more applications. Further, the monitoring systems 521 may also monitor events, performance or operating conditions of upstream applications 522 to determine whether an outage, failure or other event detected at the application is a result of one or more upstream applications 522. If the outage or failure at the application is caused by one or more upstream applications 522, then the outage or failure of the monitored application may not be attributable to performance of a responsible SRE team. Accordingly, response score, for example, may not be impacted for such outage or failure caused by other applications or services. Moreover, upstream database 523 may provide various data that may indicate an impact on performance or reliability of one or more applications 510 managed by the responsible SRE team. On the other hand, normal operation conditions in the upstream applications 522 or lack of abnormal event data in the upstream databases 523 around a time of failure of one or more applications 510 may be attributable to the responsible SRE team.

Data sources 520 may send various collections of data to the data store 530 for storage. According to exemplary aspects, the data store 530 may store presently collected data for an SRE team as well as previously collected data. In an example, previously collected data stored in the data store 530 may be utilized for calculating one or more baseline scores. Further, the data store 530 may additionally store performance metric data and other related data for other SRE teams for calculating comparative scores for determining a relative rank with respect to peer teams.

Data source 520 and data store 530 may provide collected metrics and/or data to leaderboard dashboard 550. In an example, the information from the data source 520 or the data store 530 may be pulled or pushed. The leaderboard dashboard 550 may be a user interface that may be accessed by a user to view scores, rank, baselines, metrics, action items and the like for one or more SRE teams.

The leaderboard dashboard 550, or its underlying system, may use one or more mathematical models for calculating one or more scores for the respective SRE team and/or for a corresponding service or application for which the respective SRE team is responsible. For example, mathematical models or formulations may include, without limitation, a pairwise comparison model, analytic hierarchy process (AHP) model and the like. However, aspects of the present disclosure are not limited thereto, such that one or more ML or AI algorithms may be leveraged for calculation of scores or underlying weighting in the scoring mechanism.

According to exemplary aspects, calculated scores may include an overall score for the SRE team, as well as unit scores based on certain attribute categories. In an example, attribute categories may include, without limitation, response, react, and reflect of the SRE team. Similar scores may be calculated for other SRE teams for establishing a rank. Also, average scores of other SRE teams may also be presented for comparison. Further, baseline score may be calculated based on previous performance metrics for the respective SRE team. Accordingly, based on the calculated scores, present score may be presented for the SRE team with respect to the calculated baseline to show performance level trend. Further, the SRE team's strengths and weaknesses may be gleaned from scores based on certain performance categories. For example, a team may be very strong in react category (e.g., fixing of bugs), but may be weak in the responsiveness category scoring.

In an example, response may refer to an SRE team's proactivity in preventing or minimizing an outage or other failures. React may refer to the SRE's team's ability to resolve the detected outage or failure, and/or the team's ability to minimize impact to customers or dependents during the detected outage or failure. Reflect may refer to action items or future guidance for better preventing such outages/failures, and/or minimizing impact to other parties or nodes upon such outages/failures.

In addition to the one or more scores calculated, various action items for improving the scores may be provided. According to exemplary aspects, each action item may provide a certain improvement in scoring. In an example, categories of scoring may be weighed differently from one another. More specifically, an action directed to improving the SRE team's reactiveness may increase score a larger amount that an action directed to improving the SRE team's reflectiveness.

In an example, a list of action items and/or corresponding scores and improvement thereof may be provided using one or more mathematical models or formulations. However, aspects of the present disclosure are not limited thereto, such that a list of action items and corresponding improvements to score may be provided using one or more ML or AI algorithms. Moreover, in some cases, the one or more ML or AI algorithms may also implement certain action items for improving a score.

Further, although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments.

Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for providing objective performance evaluations across site reliability engineering (SRE) teams responsible for different applications, the method comprising:
performing, using a processor and a memory:
obtaining performance metrics of an application;
capturing target performance metrics of the application via an ingestion service;
performing one or more calculations for determining a set of scores, one for each of a plurality of performance categories;
generating a rank based on the set of scores;
generating at least one action item for each of the set of scores, along with corresponding score improvement to be awarded upon completion, wherein the score improvement is different for different performance categories; and
displaying, on a user interface, at least one of the set of scores for each of the plurality of performance categories, the performance metrics corresponding to the set of scores, the rank, and the at least one action item along with corresponding score improvement to be awarded upon completion.

2. The method according to claim 1, further comprising:
wherein the application includes a monitoring system for tracking of system metrics impacted by operation of the application.

3. The method according to claim 2, further comprising:
wherein the system metrics include utilization of a technical resource.

4. The method according to claim 1, wherein the set of scores is calculated in view of baseline metrics, the baseline metrics being based on previous performance metrics of the application.

5. The method according to claim 1, wherein the set of scores is determined using at least one mathematical model.

6. The method according to claim 5, wherein the at least one mathematical model includes a pairwise comparison model or an analytic hierarchy process (AHP) model.

7. The method according to claim 5, wherein the set of scores is further determined in view of at least one of a service level agreement (SLA) and service level objective (SLO).

8. The method according to claim 1, further comprising:
aggregating the set of scores with scores of one or more applications based on a relationship between the application and the one or more applications; and
displaying, on the user interface, the aggregated scores.

9. The method according to claim 1, further comprising:
determining a maturity level of a site reliability engineering team responsible for the application based on the set of scores.

10. The method according to claim 1, wherein the set of scores are updated at predetermined intervals.

11. The method according to claim 1, wherein the rank is generated for a site reliability engineering team responsible for the application, and with respect to other SRE teams.

12. The method according to claim 1, wherein
the plurality of performance categories includes response, react and reflect,
the response referring to responsiveness of a site reliability engineering team responsible for the application in preventing or minimizing an outage or failure of the application,
the react referring to the SRE team's ability to resolve the outage or failure of the application upon occurrence, and
the reflect referring to future actions or guidance for preventing repeat occurrence of the outage of failure and/or minimizing impact to downstream applications upon occurrence of the outage or failure.

13. The method according to claim 12, wherein weighting of a score for the response is higher than weighting of the react performance category or the reflect performance category.

14. The method according to claim 12, wherein performing an action item for the response performance category will raise a score amount higher than performing an action item for the react performance category or the reflect performance category.

15. The method according to claim 1, further comprising:
determining an impact of upstream applications or services to the performance metrics of the application,
wherein the set of scores is determined based on the impact of the upstream applications or services.

16. The method according to claim 1, wherein the set of scores is normalized in view of a number of golden signals in view of data volume processed.

17. The method according to claim 1, wherein the set of scores is determined using one or more machine learning or artificial intelligence algorithms.

18. The method according to claim 1, wherein the at least one action item and the corresponding score to be awarded are determined using one or more machine learning or artificial intelligence algorithms.

19. A system for providing objective performance evaluations across site reliability engineering (SRE) teams responsible for different applications, the system comprising:
at least one processor;
at least one memory; and
at least one communication circuit,
wherein the at least one processor is configured to:
obtain performance metrics of an application;
capture target performance metrics of the application via an ingestion service;
perform one or more calculations for determining a set of scores, one for each of a plurality of performance categories;
generate a rank based on the set of scores;
generate at least one action item for each of the set of scores, along with corresponding score improvement to be awarded upon completion, wherein the score improvement is different for different performance categories; and
display, on a user interface, at least one of the set of scores for each of the plurality of performance categories, the performance metrics corresponding to the set of scores, the rank, the at least one action item along with corresponding score improvement to be awarded upon completion.

20. A non-transitory computer readable storage medium that stores a computer program for providing objective performance evaluations across site reliability engineering (SRE) teams responsible for different applications, the computer program, when executed by a processor, causing a system to perform a process comprising:
obtaining performance metrics of an application;
capturing target performance metrics of the application via an ingestion service;
performing one or more calculations for determining a set of scores, one for each of a plurality of performance categories;
generating a rank based on the set of scores;
generating at least one action item for each of the set of scores, along with corresponding score improvement to be awarded upon completion, wherein the score improvement is different for different performance categories; and
displaying, on a user interface, at least one of the set of scores for each of the plurality of performance categories, the performance metrics corresponding to the set of scores, the rank, the at least one action item along with corresponding score improvement to be awarded upon completion.
